(19) United States
(12) Patent Application Publication
(10) Pub. No.: US 2021/0314672 A1
(43) Pub. Date: Oct. 7, 2021

(54) SYSTEMS AND METHODS FOR PROVIDING ADVERTISEMENT OPTIONS WITH OTHER MEDIA

(71) Applicant: Rovi Guides, Inc., San Jose, CA (US)

(72) Inventors: Ankur Anil Aher, Kalyan (IN); Susanto Sen, Bangalore (IN)

(21) Appl. No.: 16/838,190

(22) Filed: Apr. 2, 2020

(51) Int. Cl. H04N 21/81; G06Q 30/02; H04N 21/431; H04N 21/472; G06T 11/60

(52) U.S. Cl. CPC H04N 21/812; G06Q 30/0277; G06T 11/60; H04N 21/4312; H04N 21/47217; H04N 21/8126

(57) ABSTRACT

The methods and systems described herein provide providing advertisement options along with other media on a user interface. In one example, the method and system retrieve metadata associated with an advertisement video. The method and system also identify an advertisement option based on the metadata and generate for simultaneous display a skip advertisement option and the advertisement option in a single overlay interface while at least a portion of the advertisement video is being displayed. The method and system further cause the advertisement video to be skipped upon selection of the skip advertisement option and causes additional information associated with the advertisement video to be generated for display upon selection of the advertisement option.

### BACKGROUND

The present disclosure relates to content output systems and, more particularly, to providing advertisement options along with other media on a user interface (UI).

### SUMMARY

Systems and methods are described herein for providing advertisement options along with other media on the UI. An advertisement (ad) video is often played on the UI when a user begins to consume streaming media, such as a video or audio. A countdown timer is generated to countdown time before the user is allowed to skip the corresponding advertisement video. The UI element, such as a “Skip Ad” option, is generated and displayed on the UI for the corresponding advertisement video currently being watched by the user. The Skip Ad option such as a skip ad seekbar functions as a control bar, which allows the users to skip advertisement currently being displayed on user's interface. Specifically, the Skip Ad option is displayed on the UI after the countdown time ends.

However, in today's UI, the Skip Ad option is the only function available for display to the user for the advertisement video during the countdown time. The advertisement video may not even display the brand or product name during the countdown time. Also, the user may not even focus on the advertisement video since the user's attention is on the Skip Ad option. As such, brand owners and product makers would benefit if some form of the ad was experienced by the user while implementing the Skip Ad function, such that it does not adversely affect the user media experience.

The solutions to the problems described above include generating, for simultaneous display a skip advertisement option and advertisement option in a single overlay interface. The skip advertisement option when selected by the user functions to skip the advertisement video on the UI. The advertisement option when selected by the user functions to generate and display additional information associated with the advertisement on the UI. In this way, a user can obtain the benefit of the skip advertisement option, while brand owners and product makers can obtain the benefit of still providing an advertisement option to the user at the same time. Thus, the user's media experience is not disrupted.

Systems and methods are described herein for providing advertisements with other media such as the advertisement video. For example, the system retrieves metadata associated with an advertisement video. The system identifies an advertisement option based on the metadata and generates for simultaneous display a skip advertisement option and the identified advertisement option for display in a single overlay interface while at least a portion of the advertisement video is being displayed. In one embodiment, when the skip advertisement option is selected, the system causes the advertisement video to be skipped. In other embodiment, when the advertisement option is selected, the system causes additional information associated with the advertisement video to be generated for display.

Systems and methods are also described herein for providing a user interface including the skip advertisement option and the additional information.

Systems and methods are also described herein for generating for display a countdown timer for the skip advertisement option while at least a portion of the advertisement is displayed. The skip advertisement option and the identified advertisement option are simultaneously displayed upon expiry of a countdown time of the countdown timer in a single overlay interface.

In one embodiment, the advertisement option includes at least one of a name, logo, title, tag line, font, and color associated with the advertisement video. Systems and methods described herein to determine a brand awareness factor associated with an offering in the advertisement video. Systems and methods described herein to identify at least one of the name, logo, title, tag line, font, and color based on the brand awareness factor for simultaneous display with the skip advertisement option in a single overlay interface.

Systems and methods described herein to determine a size of a display area for displaying the skip advertisement option. In one embodiment, systems and methods described herein to select at least one of the name, logo, title, tag line, font, and color associated with the advertisement video based on the size of the display area. In one embodiment, systems and methods described herein to increase the size of the display area for the simultaneous display of the skip advertisement option and the advertisement option in a single overlay interface.

Systems and method described herein to determine the advertisement option previously selected for the advertisement video. In one embodiment, systems and methods described herein to select at least one of the name, logo, title, tag line, font, and color associated with the advertisement video based on the previously determined advertisement option.

### BRIEF DESCRIPTION OF THE DRAWINGS

The above and other objects, advantages and benefits of the disclosure will be apparent upon consideration of the following detailed description, taken in conjunction with the accompanying drawings, in which like reference characters refer to like parts throughout, and in which:

FIG. 1 is a block diagram of an illustrative system for providing advertisement options with other media, in accordance with one embodiment;

FIG. 2 is an example of simultaneous display of the skip advertisement option and the advertisement option in a single overlay interface, in accordance with one embodiment;

FIG. 3 is an example of simultaneous display of the skip advertisement option and the advertisement option in a single overlay interface, in accordance with one embodiment;

FIG. 4 is an example of simultaneous display of the skip advertisement option and the countdown timer option in a single overlay interface, in accordance with one embodiment;

FIG. 5 is an illustrative block diagram showing a content output system, in accordance with one embodiment;

FIG. 6 is an illustrative block diagram showing additional details of a system for providing advertisement options with other media, in accordance with one embodiment; and

FIG. 7 depicts an illustrative flowchart of a process for providing advertisement options with other media for display on a user interface, in accordance with one embodiment.

### DETAILED DESCRIPTION

In one embodiment, methods and systems are described herein for generating, for simultaneous display a skip advertisement option and advertisement option in a single overlay interface on a user interface (UI). Methods and systems are also described herein for downloading the skip advertisement and advertisement options for simultaneous display in a single overlay interface on the UI. Additionally, methods and systems are described herein for causing the advertisement video to be skipped upon selection of the skip advertisement option. Methods and systems are further described herein for causing additional information corresponding to the advertisement option to be displayed upon selection of the advertisement option. Accordingly, a user can obtain the benefit of the skip advertisement option, while brand owners and product makers can simultaneously obtain the benefit of providing an advertisement option to the user without causing any disruption in user's media experience.

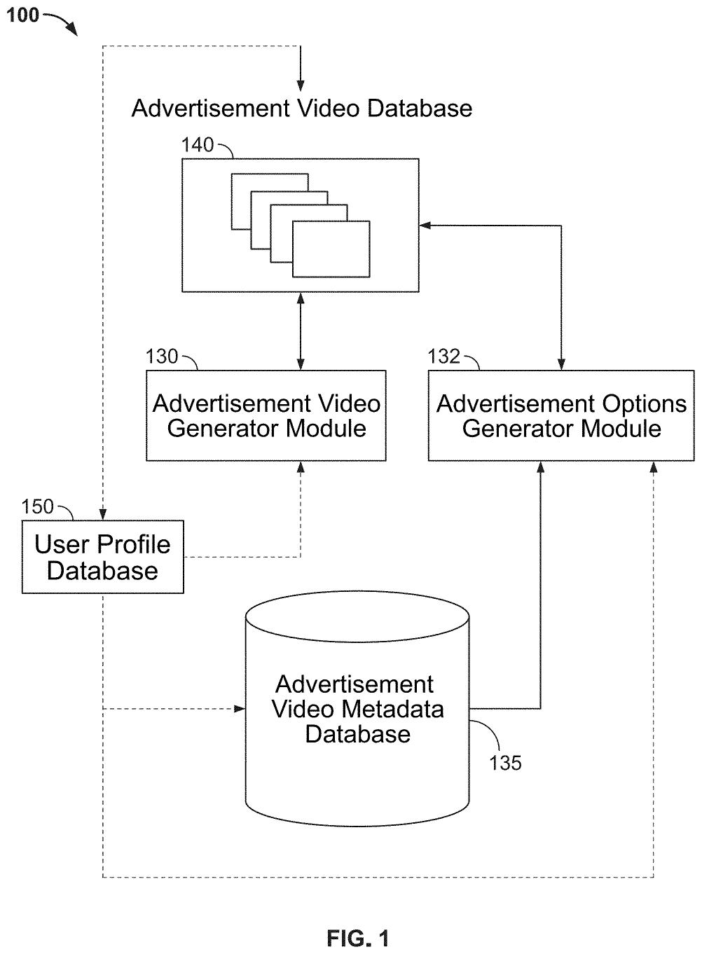

FIG. 1 illustrates a block diagram of an exemplary system 100 for providing advertisement options with other media. The system 100 includes an advertisement (ad) video generator module 130, an advertisement (ad) options generator module 132, an advertisement (ad) video metadata database (database) 135, and a user profile database 150. In one embodiment, the ad video generator module 130 generates an advertisement for display on a user interface (UI). The ad video generator module (ad video generator) 130 may also be programmed to generate ad video content utilizing an advertisement video database 140 of video content. Video data may include video frames of each scene associated with corresponding metadata. In one embodiment, the ad video generator 130 optionally utilizes data from the user profile data from the database 150 to identify the advertisement to generate for display.

User Profile data may include user preferences, content preferences and consumption history associated with a particular profile. User Profile data may include internet browsing history, social media posts, content “likes” or “dislikes,” and other data that may be analyzed by the ad video generator 130 to identify the advertisement to be generated for display on the UI. Such user profile data may also be analyzed by the ad options generator 132 to determine likelihoods of the user skipping the advertisement or watching the entire advertisement.

In one embodiment, the database 135 includes ad metadata associated with an additional information on an advertisement to be generated for display. In one embodiment, the ad metadata includes one or more ad options as the additional information corresponding to the advertisement. Some examples of the ad options of the ad metadata include ad identification (Id), title, ad duration, brand name, logo name, brand logo, brand tag line, font style, font color, a hyperlink, product name, product logo, translated version of the product/brand name, description of the product/brand, price of the product. In one embodiment, the ad metadata includes ad options that are directly related to the advertisement on the advertisement video shown on the UI. For example, the brand/product name is same as brand/product shown in the advertisement video. In one embodiment, the ad metadata includes ad options that are indirectly related to the advertisement on the advertisement video shown on the UI. For example, the brand/product name is different from brand/product shown in the advertisement video. In one embodiment, one or more of the ad options may be personalized to the user. The ad option(s) may be personalized based on user profile data such as the user's preferences in the user profile database 150. In one embodiment, the ad options are generated to be displayed as a text. In another embodiment, the ad options are generated to be displayed as an image. In one embodiment, an advertiser provides the ad metadata. In another embodiment, the system can generate the ad metadata by processing the ad video.

In one example, the ad options of the ad metadata may include the following:
Id: 12345
Title: McDonald's happy meal
Duration: 36 seconds
Brand name: McDonalds
Brand Logo: M
Brand Tag Line: I'm lovin' it
Font Style: mc_donalds.ttf
Font Color: yellow

In one embodiment, the ad options generator module (ad options generator) 132 generates a skip ad option and ad option for simultaneous display in a single overlay interface on the UI. In one embodiment, the ad options generator 132 determines the ad video to be generated by the ad video generator 130 to be displayed on the UI. In another embodiment, the ad options generator 132 accesses the advertisement video database 140 and selects the ad video to be generated to displayed on the UI. In one embodiment, the ad options generator accesses the database 135 to determines whether the ad metadata corresponding to the ad video is available. In one embodiment, the ad options generator 132 determines that the ad metadata is not available and sends the advertisement to a video processing unit (not shown) for metadata extraction and stores the extracted ad metadata in the database 135. In one embodiment, the ad options generator 132 determines that the ad metadata corresponding to the ad video is available in the database 135. In one embodiment, the ad options generator 132 identifies or selects the one or more ad options among the multiple ad options in the ad metadata. In one embodiment, the ad options generator 132 inserts the selected one or more ad options in the skip ad option for simultaneous display with the skip ad option in a single overlay interface. In one embodiment, the ad options generator 132 selects the one or more ad options based on one or more factors associated with an offering in the ad video. Some of these factors include brand awareness factor, repetitiveness factor and skip ad section area factor.

In one embodiment, the ad options generator 132 determines the brand awareness factor corresponding to the brand in the ad video in order to select the one or more ad options for display. Specifically, the ad options generator 132 determines the familiarity of the user with the brand. Such familiarity is determined based on the ad watch history of the ad video corresponding to the brand, purchase history of the products/services related to the brand by the user etc. In one embodiment, the ad options generator 132 identifies or selects the ad options based on a pre-defined brand awareness threshold of the brand awareness factor. In one embodiment, the ad options generator 132 determines whether the brand awareness by the user is less or greater than the pre-defined brand awareness threshold. If it is determined that the brand awareness by the user is less than the pre-defined brand awareness threshold, the ad options of brand name and brand logo are selected to be inserted in the ad option for the display. If it is determined that the brand awareness by the user is greater than the pre-defined brand awareness threshold, the ad options of brand tag line and brand font are selected to be inserted in the ad option for the display. In one embodiment, the ad options generator 132 may also utilize the user profile data to determine the brand awareness factor of the ad options.

In another embodiment, the ad options generator 132 determines the repetitiveness factor of the ad options for display with the corresponding the ad video in order to select the one or more ad options for display. In one embodiment, the ad options generator 132 identifies or selects the ad options for display based on previously selected ad options. In one embodiment, the ad options generator selects the ad options for display that were not previously selected for display with the corresponding video ad. In one embodiment, the ad video is repeatedly displayed on the UI. In one embodiment, the ad options generator 132 determines a count value of the ad options previously selected for display in each of the corresponding repeatedly displayed ad video. In one embodiment, the ad options generator 132 determines whether the count value of the ad option previously selected for display is greater than or less than a threshold count value. If it is determined that the count value of the ad option is less than the threshold count value, then the ad option is selected to be inserted in the ad option for the display. If it is determined that the count value of the ad option is greater than the threshold count value, then the ad option is not selected to be inserted in the ad option for the display. In one embodiment, the ad options generator 132 may also utilize the user profile data to determine the repetitiveness factor of the ad options.

In a further embodiment, the ad options generator 132 determines the skip ad section area factor in order to select the one or more ad options for display. In one embodiment, the ad options generator 132 determines size of the area in the skip ad option to be displayed. In one embodiment, the ad options generator 132 selects the one or more ad options for display based on the size of the area in the skip ad option. In one embodiment, the ad options generator 132 determines whether size of the skip ad option area is greater than or less than a size threshold. If one example, if it is determined that the size of the skip ad option area is greater than the size threshold, then brand tag lines are selected to be inserted in the ad option for display. In another example, if it is determined that the size of the skip ad option area is greater than the size threshold, then combination of brand logo and brand name is selected to be inserted in the ad option for display. If it is determined that the size of the skip ad option area is less than the size threshold, then brand logo is selected to be inserted in the ad option for display.

In one embodiment, the ad options generator 132 resizes the area of the skip ad option based on the ad options. In one example, if both the brand name and brand logo are selected to be inserted in the skip ad option, the ad generator 132 increases the area of the skip ad option in order to accommodate space for both the ad options in the skip ad option. In one embodiment, the ad options generator 132 reduces the area of the skip ad option if only the brand logo is selected to be inserted in the skip ad option. In another embodiment, the ad options generator 132 resizes the area of the skip ad option based on the ad options. In one embodiment, the ad options generator 132 determines whether the focus of the user is on the ad video or the skip ad option. The ad options generator 132 may use an eye gazing tracking system to determine focus of the user. In one example, if it is determined that the user's focus is on the ad video, the ad options generator 132 reduces the area of the skip ad option. In another example, if it is determined that the user's focus is on the skip ad option, the ad options generator 132 increases the area of the skip ad option.

In one embodiment, the ad options generator 132 generates the selected one or more ad options in the ad metadata for simultaneous display with the skip ad option in a single overlay interface on the UI. Although, the ad options generator 132 described herein generates both the skip ad and the ad option, it is known to one skilled in the art to that two separate modules may be utilized such that one module functions to generate and display the skip ad and another module functions to generate and displays the ad option.

In one embodiment, the system determines that the skip ad option is selected by the user on the UI. The system then causes the advertisement video to be skipped. In another embodiment, the system determines that the one or ad options is selected by the user. The system then causes additional information associated with the ad option to be displayed on the UI. The additional information includes the ad metadata corresponding to the ad option. In this way, the system allows the user to still have the skip ad option, while brand owners and product makers can still have part of the advertisement provided to the user while implementing the skip ad option. Thus, the user's media experience is not disrupted.

In one embodiment, the ad options generator 132 also generates a countdown timer. The countdown timer functions to count down a specific time. In one example, the ad options generator 132 displays the countdown timer on the UI. In another example, the ad options generator 132 displays the countdown timer prior to displaying the skip ad option and the ad option while the ad video is being displayed on the UI. In one embodiment, the ad options generator 130 displays the skip ad option and the ad option immediately after expiry of the specific time in the countdown timer. In another embodiment, the ad video options generator 132 simultaneously displays the ad option, the skip ad option in a single overlay interface, the countdown timer while the ad video is being displayed on the UI. In a further embodiment, the ad options generator 132 generates for simultaneous display the countdown timer and the ad option in a single overlay interface.

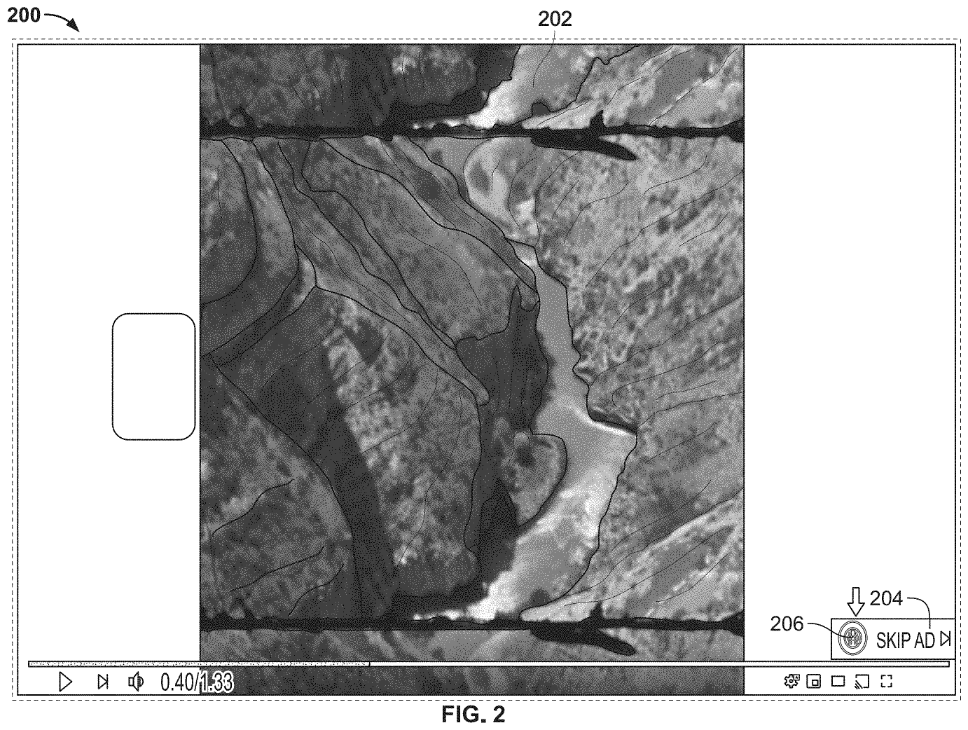

FIG. 2 illustrates one example of the simultaneous display of the ad option and the skip ad option in a single overlay interface. The ad video 202 corresponding to Starbucks Coffee along with the skip ad option 204 is generated for display on an UI 200. In one embodiment, only ad option available in the ad metadata for the ad video 202 is Starbucks brand logo, e.g., [symbol] 206. In another embodiment, the Starbucks brand logo [symbol] 206 is selected among other ad options in the ad metadata for the ad video 202. In one embodiment, the Starbucks brand logo [symbol] 206 is selected based on a determination that the user is familiar or is aware of the Starbucks brand logo [symbol] 206. The ad options generator 132 generates for simultaneous display the skip ad option 204 and the Starbucks brand logo [symbol] in a single overlay interface 206. In one example, the Starbucks brand logo [symbol] 206 is emphasized by the brand's font. In one embodiment, a product of Starbucks Coffee may be selected for display upon a determination that the user is not familiar with the Starbucks brand logo. Although, not shown, in one embodiment, both the product of Starbucks Coffee and the Starbucks brand logo are selected for display on the UI 200. In one embodiment, the ad options generator, increases area of the skip ad option 204 in order to accommodate the Starbucks brand logo [symbol] 206 in the skip ad option 204. Thus, the brand logo [symbol] 206 is displayed simultaneously with the skip ad option in a single overlay interface 204 on the UI 200 as shown in FIG. 2A. In one embodiment, the brand logo [symbol] 206 is a hyperlink brand logo such that upon user's selection of the this logo, the user will be presented with another web page related to the advertisement and/or advertiser associated with the advertisement. In another embodiment, the user may choose the skip ad option 204.

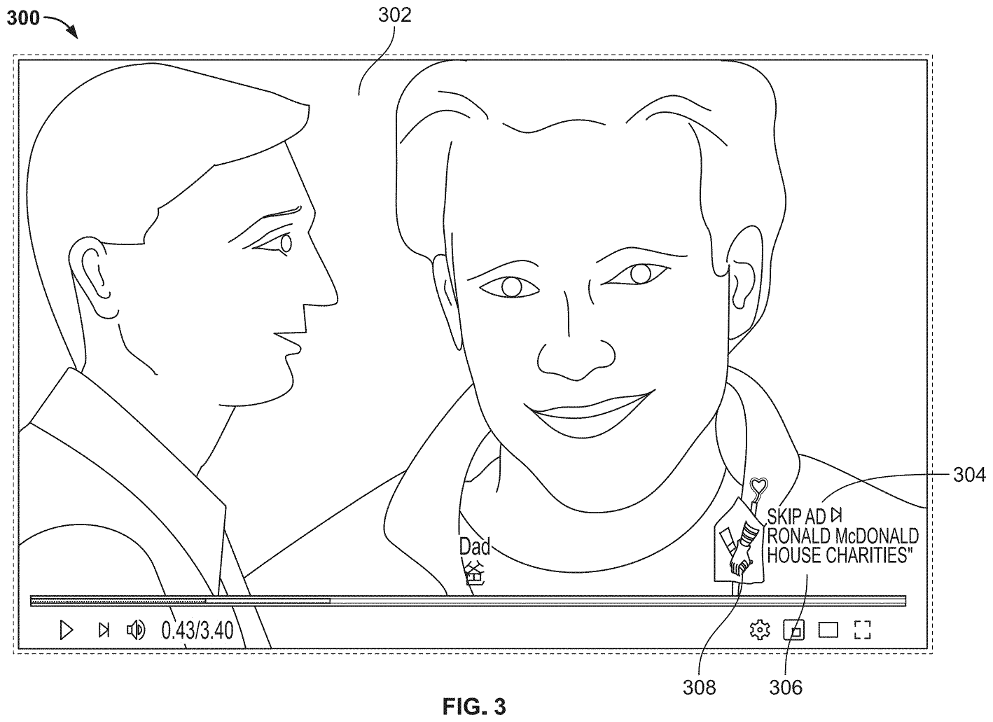

FIG. 3 illustrates another example of the simultaneous display of an ad option and the skip ad option in a single overlay interface. The ad video 302 corresponding to McDonald's along with a skip ad option 304 is generated for display on an UI 300. In one embodiment, only ad options available in the ad metadata for the ad video 302 are brand name, RONALD MCDONALD HOUSE CHARITIES 306 and corresponding brand logo, e.g., [symbol] 308. In another embodiment, the brand name RONALD MCDONALD HOUSE CHARITIES 306 and the brand logo, [symbol] 308 are selected among other ad options in the ad metadata for the ad video 302. In one embodiment, the ad options generator 132 optimizes area of the skip ad option 304 in order to fit both the brand name and the brand logo. The ad options generator 132 generates for simultaneous display the skip ad option in a single overlay interface 304 including the brand name, RONALD MCDONALD HOUSE CHARITIES 306 and the brand logo, [symbol] 308. Thus, the brand name, RONALD MCDONALD HOUSE CHARITIES 306 and the brand logo [symbol] 308 are displayed simultaneously with the skip ad option in a single overlay interface 304 on the UI 300 as shown in FIG. 3. In one embodiment, the ad options generator, increases area of the skip ad option 304 to optimally adjust the skip ad option 304 within the brand name RONALD MCDONALD HOUSE CHARITIES 306 and the brand logo, [symbol] 308.

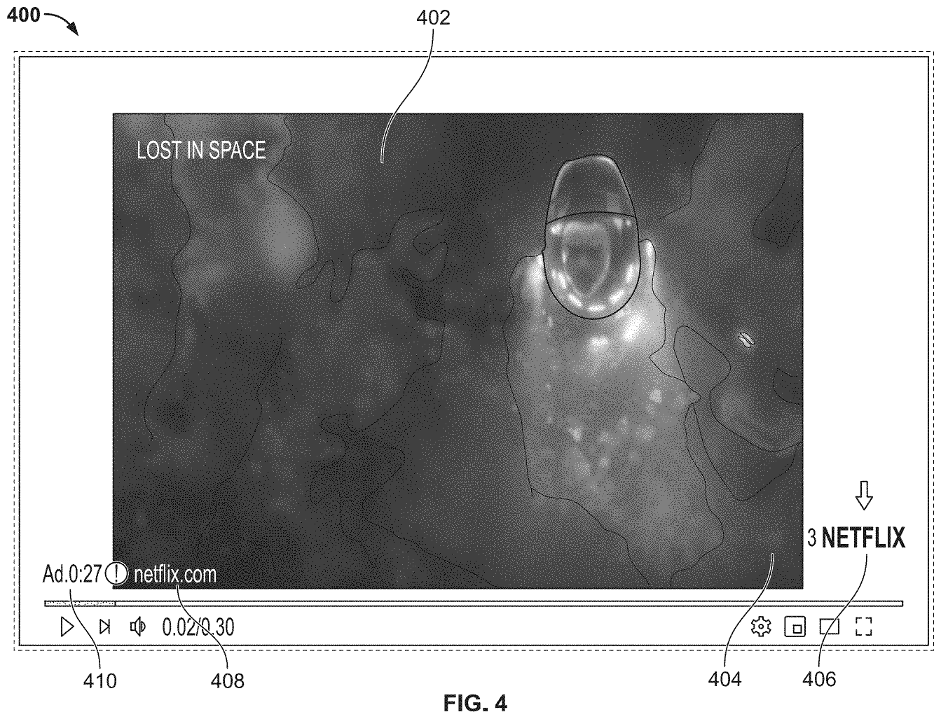

FIG. 4 illustrates an example of the simultaneous display of an ad option and a countdown timer in a single overlay interface. The ad video 402 corresponding to Netflix along with a countdown timer 404 is generated for display on an UI 400. In one embodiment, only ad options available in the ad metadata for the ad video 402 are the brand name/logo NETFLIX 406, the brand website link, Netflix.com 408 and the ad duration 410. In another embodiment, the brand name/logo NETFLIX 406 the brand website link, Netflix.com 408 and the ad duration 410 are selected among other ad options in the ad metadata for the ad video 402. In one embodiment, the ad options generator 132 generates for simultaneous display the countdown timer 404 and the brand name NETFLIX 406 in a single overlay interface. Thus, the brand name NETFLIX 406 is displayed simultaneously in a single overlay interface with the countdown timer 404 on the UI 400 as shown in FIG. 4. Additionally, displayed on the UI 400 are the Netflix.com 408 along with the ad duration 410. In one embodiment, the ad generator 132 determines that the user is not focused on the ad video 402 and the user is focused on the brand name NETFLIX 406 during the countdown of the ad video 402. The ad generator 132 may increase area including the NETFLIX 406 and the countdown timer 404 on the UI 400.

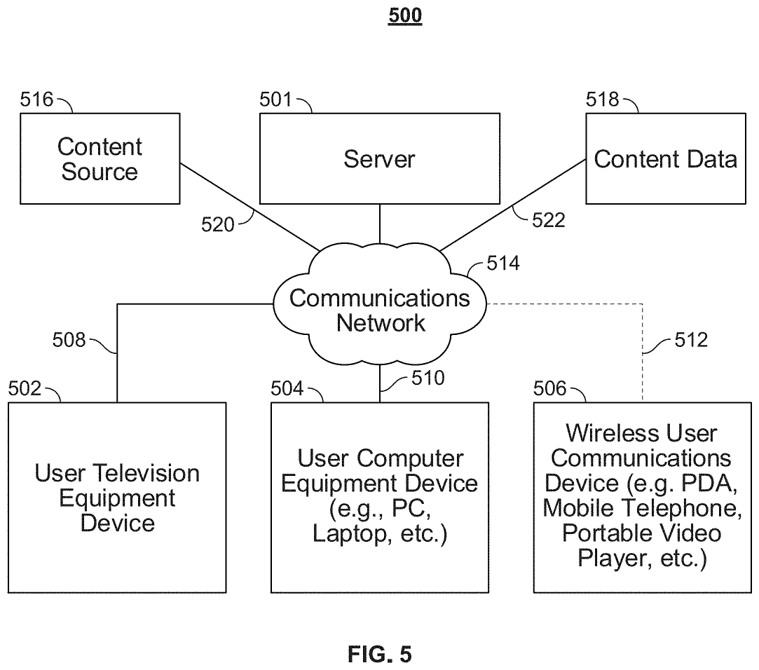

FIG. 5 illustrates an example of a system 500 in accordance with one embodiment of the present application. The system 500 includes a user television equipment 502, user computer equipment 504, wireless user communications device 506, or any other type of user equipment suitable for accessing content, such as a non-portable gaming machine. For simplicity, these devices may be referred to herein collectively as user equipment or devices. Devices, on which an application may be implemented, may function as a standalone device or may be part of a network of devices. Various network configurations of devices may be implemented and are discussed in more detail below.

A device utilizing at least some of the system features described above in connection with FIG. 1 may not be classified solely as user television equipment 502, user computer equipment 504, or a wireless user communications device 506. For example, user television equipment 502 may, like some user computer equipment 504, be Internet-enabled allowing for access to Internet content, while user computer equipment 504 may, like some television equipment 502, include a tuner allowing for access to television programming. The application may have the same layout on various different types of user equipment or may be tailored to the display capabilities of the user equipment. For example, on user computer equipment 504, the content application may be provided as a web site accessed by a web browser. In another example, the content application may be scaled down for wireless user communications devices 506.

In a content output system 500, there is typically more than one of each type of device but only one of each is shown in FIG. 5 to avoid overcomplicating the drawing. In addition, each user may utilize more than one type of device and also more than one of each type of device.

In some embodiments, a device (e.g., user television equipment 502, user computer equipment 504, wireless user communications device 506) may be referred to as a “second device.” For example, a second device may provide an interface for adjusting settings and display preferences of the first device. In some embodiments, the second device is configured for interacting with other second devices or for interacting with a social network. The second screen device can be located in the same room as the first device, a different room from the first device but in the same house or building, or in a different building from the first device.

The user may also set various settings to maintain consistent application settings across in-home devices and remote devices. For example, if a user enables selection of related content segments on their personal computer at their office, this feature would also be enabled on the user's in-home devices (e.g., user television equipment and user computer equipment) as well as the user's mobile devices, if desired. Therefore, changes made on one device can change the content experienced on another device, regardless of whether they are the same or a different type of device. In addition, the changes made may be based on settings input by a user, as well as user activity monitored by the content application. In addition, two devices can work together to provide functionality for the user. For example, a first device can determine a current portion of the content being output to a user and instruct a second device to determine content segments related to the current portion of the content.

The devices may be coupled to communications network 514. Namely, user television equipment 502, user computer equipment 504, and wireless user communications device 506 are coupled to communications network 514 via communications paths 508, 510, and 512, respectively. Communications network 514 may be one or more networks including the Internet, a mobile phone network, mobile voice or data network (e.g., a 5G or LTE network), cable network, public switched telephone network, or other types of communications network or combinations of communications networks. Paths 508, 510, and 512 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 512 is drawn with dotted lines to indicate that in the exemplary embodiment shown in FIG. 5 it is a wireless path and paths 508 and 510 are drawn as solid lines to indicate they are wired paths (although these paths may be wireless paths, if desired). Communications with the devices may be provided by one or more of these communications paths but are shown as a single path in FIG. 5 to avoid overcomplicating the drawing.

Although communications paths are not drawn between devices, these devices may communicate directly with each other via communication paths, such as those described above in connection with paths 508, 510, and 512, as well as other short-range point-to-point communication paths, such as USB cables, IEEE 1394 cables, wireless paths (e.g., Bluetooth, infrared, IEEE 502-11x, etc.), or other short-range communication via wired or wireless paths. BLUETOOTH is a certification mark owned by Bluetooth SIG, INC. The devices may also communicate with each other directly through an indirect path via communications network 514.

System 500 includes content source 516 and content data source 518 coupled to communications network 514 via communication paths 520 and 522, respectively. Paths 520 and 522 may include any of the communication paths described above in connection with paths 508, 510, and 512. Communications with the content source 516 and content data source 518 may be exchanged over one or more communications paths but are shown as a single path in FIG. 5 to avoid overcomplicating the drawing. In addition, there may be more than one of each of content source 516 and content data source 518, but only one of each is shown in FIG. 5 to avoid overcomplicating the drawing. If desired, content source 516 and content data source 518 may be integrated as one source device. Although communications between sources 516 and 518 with devices 502, 504, and 506 are shown as through communications network 514, in some embodiments, sources 516 and 518 may communicate directly with devices 502, 504, and 506 via communication paths (not shown) such as those described above in connection with paths 508, 510, and 512.

Content source 516 may include one or more types of content distribution equipment including a television distribution facility, cable system headend, satellite distribution facility, programming sources (e.g., television broadcasters), intermediate distribution facilities and/or servers, Internet providers, on-demand content servers, and other content providers. Content source 516 may be the originator of content (e.g., a television broadcaster, a Webcast provider, etc.) or may not be the originator of content (e.g., an on-demand content provider, an Internet provider of content of broadcast programs for downloading, etc.). Content source 516 may include cable sources, satellite providers, on-demand providers, Internet providers, over-the-top content providers, or other providers of content. Content source 516 may also include a remote content server used to store different types of content (including advertisement video and/or other video content selected by a user), in a location remote from any of the devices. Systems and methods for remote storage of content and providing remotely stored content to user equipment are discussed in greater detail in connection with Ellis et al., U.S. Pat. No. 7,761,892, issued Jul. 20, 2010, which is hereby incorporated by reference herein in its entirety.

Content data source 518 may provide data related to the content. Content data may be provided to the devices using any suitable approach. In some embodiments, the content application may be a stand-alone interactive television program guide that receives program guide data via a data feed (e.g., a continuous feed or trickle feed). Program schedule data and other content data may be provided to the user equipment on a television channel sideband, using an in-band digital signal, using an out-of-band digital signal, or by any other suitable data transmission technique. Program schedule data and other content data may be provided to user equipment on multiple analog or digital television channels.

In some embodiments, content data from content data source 518 may be provided to user's equipment using a client-server approach. For example, a user equipment device may pull content data from a server, 501 or the server 501 may push content data to a user equipment device via the communications network. In some embodiments, a content application client residing on the user's equipment may initiate sessions with source 518 to obtain content data when needed, e.g., when the content data is out of date or when the device requests the data. Content data may be provided to the user equipment with any suitable frequency (e.g., continuously, daily, a user-specified period of time, a system-specified period of time, in response to a request from user equipment, etc.). Content data source 518 may provide devices 502, 504, and 506 the application itself or software updates for the application.

In some embodiments, the content data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The content data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of less or more than one year. The content data may include a model (e.g., a survivor model) used for generating a score that indicates a likelihood a given user will terminate access to a service/source. For example, the application may monitor a user's engagement with content to generate a value or score that indicates a likelihood of whether the given user will terminate access to a particular service or source. In particular, a higher score may indicate a higher level of confidence that the user will terminate access to a particular service or source. Based on the score, the application may generate promotions that entice the user to keep the particular service or source indicated by the score as one to which the user will likely terminate access. The content data may include advertisement video metadata files pertaining to the advertisement video e.g., one or more ad options corresponding to the advertisement. Some examples of the ad options of the ad metadata include ad identification (Id), title, ad duration, brand name, logo name, brand logo, brand tag line, font style, font color, brand website link, etc. The content data may also include user profiles to identify the advertisement to generate for display based on user's internet browsing history, social media posts, content “likes” or “dislikes” and other data that may be analyzed to identify the advertisement generated for display. The user profile data may also be used to determine likelihoods of the user skipping the advertisement or watching the entire advertisement. The user profile data may also be used to determine which ad option of the ad metadata to select for display to the user. For example, content data may include information characterizing the advertisement video content such as the director, producer, actors, activities occurring during the advertisement video content, locations the content was created, any description of the content context or the content production, or any suitable combination thereof.

Content and/or content data delivered to devices 502, 504, and 506 may be over-the-top (OTT) content. OTT content delivery allows Internet-enabled user devices, including any device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. YouTube is a trademark owned by Google Inc., Netflix is a trademark owned by Netflix Inc., and Hulu is a trademark owned by Hulu, LLC. OTT content providers may additionally or alternatively provide content data described above.

Content output system 500 is intended to illustrate a number of approaches, or network configurations, by which devices and sources of content and content data may communicate with each other for the purpose of implementing the functionality described herein. The embodiments described herein may be applied in any one or a subset of these approaches, or in a system employing other approaches for downloading and displaying the content. The following four approaches provide specific illustrations of the generalized example of FIG. 5.

In one approach, devices may communicate with each other within a home network. Devices can communicate with each other directly via short-range point-to-point communication schemes described above, via indirect paths through a hub or other similar device provided on a home network, or via communications network 514. Each of the multiple individuals in a single home may operate different devices on the home network. As a result, it may be desirable for various content application information or settings to be communicated between the different devices. For example, it may be desirable for users to maintain consistent application settings on different devices within a home network, as described in greater detail in Ellis et al., U.S. Patent Publication No. 2005/0251827, filed Jul. 11, 2005. Different types of devices in a home network may also communicate with each other to transmit content. For example, a user may use content navigation button on one device while the content is transmitted to a second device to be generated for display.

In a second approach, users may have multiple types of user equipment by which they access content. For example, some users may have home networks that are accessed by in-home and mobile devices. Users may control in-home devices via an application implemented on a remote device. For example, users may access an online application on a website via a personal computer at their office, or a mobile device such as a PDA or web-enabled mobile telephone. The user may set various settings (e.g., recordings, reminders, timelines and the locations of the content and the related segments display enablement, or other settings) on the online content application to control the user's in-home equipment. The online application may control the user's equipment directly, or by communicating with an application on the user's in-home equipment. Various systems and methods for devices communicating, where the devices are in locations remote from each other, is discussed in, for example, Ellis et al., U.S. Pat. No. 8,046,801, issued Oct. 25, 2011, which is hereby incorporated by reference herein in its entirety.

In a third approach, users of devices inside and outside a home can use their application to communicate directly with content source 516 to access content. Specifically, within a home, users of user television equipment 502 and user computer equipment 504 may access the application to navigate among and locate desirable content. Users may also access the application outside of the home using wireless user communications devices 506 to navigate among and locate desirable content.

In a fourth approach, devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 514. These cloud resources may include one or more content sources 516 and one or more content data sources 518. In addition, or in the alternative, the remote computing sites may include other devices, such as user television equipment 502, user computer equipment 504, and wireless user communications device 506. For example, the other devices may provide access to a stored copy of a video or a streamed video. In such embodiments, devices may operate in a peer-to-peer manner without communicating with a central server.

The cloud provides access to services, such as content storage, content sharing, or social networking services, among other examples, as well as access to any content described above, for devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a device to store content to the cloud and to receive content from the cloud rather than storing content locally and accessing locally-stored content.

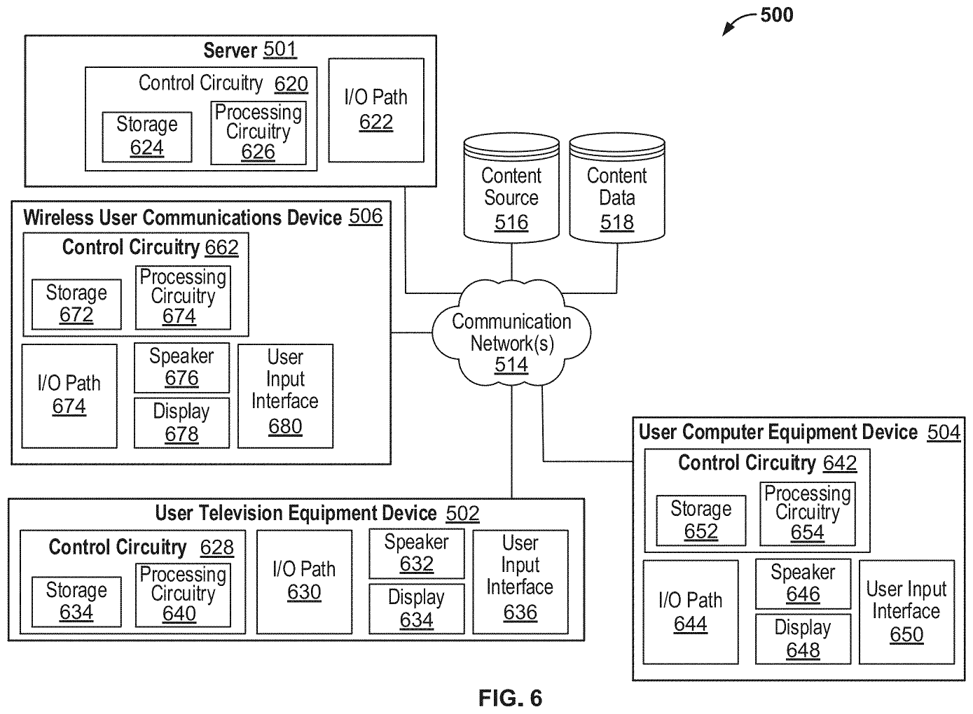

Cloud resources may be accessed by a device using, for example, a web browser, an application, a desktop application, a mobile application, and/or any combination of access applications of the same. The device may be a cloud client that relies on cloud computing for application delivery, or the device may have some functionality without access to cloud resources. For example, some applications running on the device may be cloud applications, i.e., applications delivered as a service over the Internet, while other applications may be stored and run on the device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, devices can use cloud resources for processing operations such as the processing operations performed by processing circuitry described in relation to FIG. 6 below.

Any one or more of user television equipment 502, user computer equipment 504, and wireless user communications device 506 of FIG. 5 can be used to provide a thorough and efficient content consumption experience. For example, the devices of the present disclosure can generate for simultaneous display the skip advertisement option and the advertisement option along with the advertisement in a single overlay interface on a user interface.

FIG. 6 is an illustrative block diagram showing additional details of an example of system 500 for generating a graphically animated audience, in accordance with some embodiments of the disclosure. Although FIG. 6 shows system 500 as including a number and configuration of individual components, in some embodiments, any number of the components of system 100 may be combined and/or integrated as one device. Because FIG. 6 shows many of the same components described above in connection with FIG. 1 and/or FIG. 5, those components are not reintroduced here. In some embodiments, system 500 excludes server 501 and functionality that would otherwise be implemented by server 501 is instead implemented by other components of system 500, such as user television equipment device 502, user computer equipment device 504 and/or wireless user communications device 506, collectively devices 502, 504 and/or 506. In still other embodiments, server 501 works in conjunction with devices 502, 504 and/or 506 to implement certain functionality described herein in a distributed or cooperative manner.

Server 501 includes control circuitry 620 and input/output (hereinafter “I/O”) path 622, and control circuitry 620 includes storage 624 and processing circuitry 626. Device 502 includes control circuitry 628, I/O path 630, speaker 632, display 634, and user input interface 636. Control circuitry 628 includes storage 638 and processing circuitry 640. Device 504 includes control circuitry 642, I/O path 644, speaker 646, display 648, and user input interface 650. Control circuitry 642 includes storage 652 and processing circuitry 654. Device 506 includes control circuitry 662, I/O path 674, speaker 676, display 678 and user input interface 680. Control circuitry 662 includes storage 672 and processing circuitry 674. Control circuitry 620, 628, and/or 662, may be based on any suitable processing circuitry such as processing circuitry 626, 640, 654 and/or 674. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor).

Each of storage 624, storage 638, storage 652, storage 672 and/or storages of other components of system 500 (e.g., storages of databases 135, 140 and 150 and/or the like) may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 624, storage 638, storage 652, storage 672 and/or storages of other components of system 500 may be used to store various types of content, metadata, and or other types of data. Non-volatile memory may also be used (e.g., to launch a boot-up routine and other instructions). Cloud-based storage may be used to supplement storages 624, 638, 652, 672 or instead of storages 624, 638, 652, 672. In some embodiments, control circuitry 620, 628, 642, and/or 662 executes instructions for an application stored in memory (e.g., storage 624, 638, 652 and/or 672). Specifically, control circuitry 620, 628, 642, and/or 662 may be instructed by the application to perform the functions discussed herein. In some implementations, any action performed by control circuitry 620, 628, 642, and/or 662 may be based on instructions received from the application. For example, the application may be implemented as software or a set of executable instructions that may be stored in storage 624, 638, 652 and/or 672 and executed by control circuitry 620, 628, 642, and/or 662. In some embodiments, the application may be a client/server application where only a client application resides on user television equipment device, 502, user computer equipment device 504 and/or wireless user communications device 506, and a server application resides on server 501.

The application may be implemented using any suitable architecture. For example, it may be a stand-alone application wholly implemented on devices 502, 504 and/or 506. In such an approach, instructions for the application are stored locally (e.g., in storage 638 or 652 or 672), and data for use by the application is downloaded on a periodic basis (e.g., from an out-of-band feed, from an Internet resource, or using another suitable approach). Control circuitry 628, 642 or 662 may retrieve instructions for the application from storage 638, 652 or 672 and process the instructions to perform the functionality described herein. Based on the processed instructions, control circuitry 628, 642 or 662 may determine what action to perform when input is received from user input interface 636, 650 or 680.

In client/server-based embodiments, control circuitry 628, 642 and/or 662 may include communication circuitry suitable for communicating with an application server (e.g., server 501) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 514). In another example of a client/server-based application, control circuitry 628, 642 and/or 662 runs a web browser that interprets web pages provided by a remote server (e.g., server 501). For example, the remote server may store the instructions for the application in a storage device. The remote server may process the stored instructions using circuitry (e.g., control circuitry 620) and/or generate displays. Devices 502, 504 and/or 506 may receive the displays generated by the remote server and may display the content of the displays locally via display 634, 648 and/or 678. This way, the processing of the instructions is performed remotely (e.g., by server 501) while the resulting displays, such as the display windows described elsewhere herein, are provided locally on devices 502, 504 and/or 506. Devices 502, 504 and/or 506 may receive inputs from the user via input interface 636 and/or 650 and transmit those inputs to the remote server for processing and generating the corresponding displays.

A user may send instructions to control circuitry 628, 642 and/or 662 using user input interface 636, 650 and/or 680. User input interface 636, 650 and/or 680 may be any suitable user interface, such as a remote control, trackball, keypad, keyboard, touchscreen, touchpad, stylus, joystick, voice recognition interface, gaming controller, or other user input interfaces. User input interface 636, 650 and/or 680 may be integrated with or combined with display 634, 648 and/or 678, respectively, which may be a monitor, a television, a liquid crystal display (LCD), an electronic ink display, or any other equipment suitable for displaying visual images.

Server 501 and devices 502, 504 and/or 506 may transmit and receive content and data via one or more of I/O paths 622, 630, 644, and 674. For instance, I/O path 622, I/O path 630, I/O path 644 and/or I/O path 674 may include a communication port configured to transmit and/or receive (for instance to and/or from databases 135, 140, and/or 150), via communication network 514, content item identifiers, natural language queries, and/or other data. Control circuitry 620, 628, 642 and 662 may be used to send and receive commands, requests, and other suitable data using I/O paths 622, 630, 644, 674

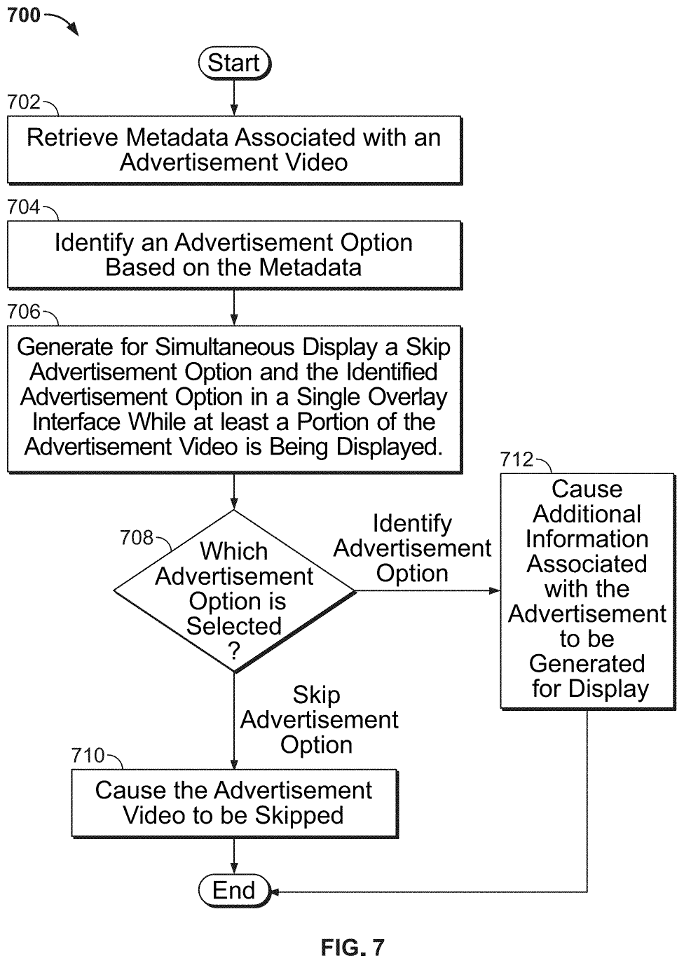

FIG. 7 depicts an illustrative flowchart of a process 700 for providing advertising options with other media on a user interface (UI) interface, in accordance with one embodiment. It should be noted that the steps of process 700 can be performed by control circuitry 628 as part of a device having a display 634 in FIG. 6 or control circuitry 642 part of a device having a display 648 in FIG. 6 or distributed over a combination of both.

At step 702, the system retrieves metadata associated with an advertisement video. As discussed above, the metadata associated with the advertisement video includes identification, title, duration, brand name, brand logo, brand tag line, font style, font color, brand website link etc. In one embodiment, the advertisement video is selected to be generated and displayed on the UI before the system retrieves the metadata. In another embodiment, the advertisement video is selected to generated and displayed at the time system retrieves the metadata. In a further embodiment, the advertisement video is selected to be generated and displayed on the UI after the system retrieves the metadata.

At step 704, the system identifies an advertisement option based on the metadata. In one embodiment, an advertisement option is identified based on the metadata available for the advertisement. In one example, only the brand logo of the metadata is available. In another example, brand name, brand logo and brand tag line are available. In a further example, all of the metadata is available. In one embodiment, the system determines which metadata to select as the advertisement option based on one or more factors. As discussed above, the factors include brand awareness factor, repetitiveness factor and skip ad section area factor.

At step 706, the system generates for simultaneous display a skip advertisement option and the identified advertisement option in a single overlay interface while at least a portion of the advertisement video is being displayed. At step 708, the system determines which advertisement option is selected. Upon determination that the skip advertisement option is selected at step 708, the system causes the advertisement video to be skipped at step 710. Upon determination that the identified advertisement option is selected at step 708, the system causes additional information associated with the identified advertisement option to be generated for displayed at step 712. As discussed above, such additional information includes the ad metadata corresponding to the identified advertisement option. Accordingly, the system allows the user to still have the skip ad option, while brand owners and product makers can still have part of the advertisement provided to the user while implementing the skip ad option. Thus, the user's media experience is not disrupted.

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method for providing advertisements with other media, comprising:
retrieving metadata associated with an advertisement video;
identifying an advertisement option based on the metadata;
selecting a single overlay interface from among a plurality of overlay interfaces based on a brand awareness factor associated with an offering in the advertisement video; and
generating for simultaneous display a skip advertisement option and the identified advertisement option for display in the single overlay interface while at least a portion of the advertisement video is being displayed,
wherein the skip advertisement option is selectable to cause the advertisement video to be skipped and the identified advertisement option is selectable to cause additional information associated with the advertisement video to be generated for display.

2. The method of claim 1, further comprising:
providing a user interface comprising the skip advertisement option and the additional information associated with the advertisement video.

3. The method of claim 1, further comprising:
generating for display a countdown timer for the skip advertisement option,
wherein the skip advertisement option and the identified advertisement option are generated for simultaneous display in the single overlay interface upon expiry of a countdown time of the countdown timer.

4. The method of claim 1, wherein the identified advertisement option comprises at least one of a name, logo, title, tag line, font, and color associated with the advertisement video.

5. The method of claim 1, wherein the identified advertisement option is identified based on at least one of an awareness factor of an offering in the advertisement video, an area provided for display of the selected data and repetitiveness of the selected data.

6. (canceled)

7. The method of claim 1, further comprising identifying at least one of the name, logo, title, tag line, font, and color based on the brand awareness factor for simultaneous display with the skip advertisement option in the single overlay interface.

8. The method of claim 1, further comprising determining a size of a display area for displaying the skip advertisement option.

9. The method of claim 8, further comprising selecting at least one of the name, logo, title, tag line, font, and color associated with the advertisement video based on the size of the display area.

10. The method of claim 8, further comprising increasing the display area for the simultaneous display of the skip advertisement option and the identified advertisement option in the single overlay interface.

11. The method of claim 1, further comprising determining the identified advertisement option previously selected for the advertisement video.

12. A system for providing advertisements with other media, comprising:
memory storing instructions and metadata associated with an advertisement video; and
control circuitry configured to execute the instructions to:
retrieve the metadata associated with the advertisement video;
select a single overlay interface from among a plurality of overlay interfaces based on a brand awareness factor associated with an offering in the advertisement video;
identify an advertisement option based on the metadata; and
generate for simultaneous display a skip advertisement option and the advertisement option in the single overlay interface while at least a portion of the advertisement video is being displayed,
wherein the skip advertisement option is selectable to cause the advertisement video to be skipped and the identified advertisement option is selectable to cause additional information associated with the advertisement video to be generated for display.

13. The system of claim 12 wherein the control circuitry is further configured to:
provide a user interface comprising the skip advertisement option and the additional information associated with the advertisement video.

14. The system of claim 12, wherein the control circuitry is further configured to:
generate for display a countdown timer for the skip advertisement option,
wherein the skip advertisement option and the identified advertisement option are generated for simultaneous display in the single overlay interface upon expiry of a countdown time of the countdown timer.

15. The system of claim 12, wherein the identified advertisement option comprises at least one of a name, logo, title, tag line, font, and color associated with the advertisement video.

16. (canceled)

17. The system of claim 12, wherein the control circuitry is further configured to identify at least one of the name, logo, title, tag line, font, and color based on the brand awareness factor for simultaneous display with the skip advertisement option in the single overlay interface.

18. The system of claim 12, wherein the control circuitry is further configured to determine a size of a display area for displaying the skip advertisement option.

19. The system of claim 18, wherein the control circuitry is further configured to select at least one of the name, logo, title, tag line, font, and color associated with the advertisement video based on the size of the display area.

20. The system of claim 18, wherein the control circuitry is further configured to increase the size of the display area for the simultaneous display of the skip advertisement option and the identified advertisement option in the single overlay interface.

21. The system of claim 15, wherein the control circuitry is further configured to determine the identified advertisement option previously selected for the advertisement video.

22. The system of claim 21, wherein the control circuitry is further configured to select at least one of the name, logo, title, tag line, font, and color associated with the advertisement video based on the previously determined advertisement option.

23.-33. (canceled)

34. The method of claim 1 wherein the advertisement option is identified based on a pre-defined brand awareness threshold associated with the brand awareness factor.

35. The system of claim 12 wherein the advertisement option is identified based on a pre-defined brand awareness threshold associated with the brand awareness factor.
